(19) United States
(12) Patent Application Publication
(10) Pub. No.: US 2024/0066907 A1
(43) Pub. Date: Feb. 29, 2024

(54) Book Learning Tool

(71) Applicant: Roger Francis Moonen, Lilburn, GA (US)

(72) Inventor: Roger Francis Moonen, Lilburn, GA (US)

(21) Appl. No.: 17/803,555

(22) Filed: Aug. 29, 2022

(51) Int. Cl. B42D 1/00; B42D 5/00

(52) U.S. Cl. CPC B42D 1/007; B42D 5/005; B42P 2241/18

(57) ABSTRACT

This invention provides all the physical tools and unique note taking guidelines to ease and enhance learning while reading a book. The tools and short form guidelines are contained in a holder that is attached within a book, semi-concealed so the tools are handy while reading, and the book is as portable as the book alone. The said unique guidelines accommodate classical note taking, but also feature unique fast simple sketches to locate the text of importance and provide immediate visible hierarchy to that importance. This importance is incorporated into a very unique lookup file that provides the reader fast access back to the reading notes and newly gained knowledge. All notes are written directly into the book, no pages are added, the physical materials are stored within the book, thus the book is a single entity, that is a valuable reference and a long term resource for the reader.

### (1) BACKGROUND OF THE INVENTION

### The Field of Endeavor to which this Invention Pertains

A book learning tool that provides ready access to the physical materials, and unique note taking guidelines; to ease and enhance note taking and learning, while reading. The guidelines also create a file that provides fast access back to the reading notes; all notes and physical materials are stored within the book, thus making the book and all notes a single entity, that is a valuable reference and a long term resource for the reader.

### Background

In reading a book, it is common to start reading, then realize you want to identify some specific information you've just read, so that you can help yourself remember, and also refer back to it later. Then, you must stop, find a pencil, pen, or color marker, or, a separate note paper to write on. You don't want to lose your place, so you grab the nearest object to hold your book open because you don't have a book mark. As you read further, you come across some information you want to make a note of, to take with you, without carrying the book. So you grab a piece of scrap paper from somewhere near you.

As you later read further into the book, especially for a text of your high interest, one you really want to learn from, or a highly technical material with a lot of detail; you encounter more items you want to commit to memory, but realize it is too much. So you then need, to not just identify the book's pertinent information with your underlinings, or with the marks and remarks you have made in the margins; you also want to add a means to highlight and tabulate especially important and unique items; so that you can easily find your way back to them when you want them. If you do not mark directly in the book, this task becomes even more slow and cumbersome. Either way, without a technique to keep track, it can become difficult to remember, and time consuming to find, where in the book, you have read what.

Further, the different parts of your peak interest are usually not just in one place in the book. Authors typically discuss the many different aspects of a topic in different chapters. To better comprehend and learn a subject matter, you realize it is necessary to go back and forth between the author's different discussions of the topic. So you realize you also need to cross reference between where each discussion is located in order to quickly find the information you want, especially when needed at a later date.

### (2) BRIEF SUMMARY OF THE INVENTION

This invention provides all the tools and guidelines necessary to take notes that ease and enhance learning while reading a book. It features a holder that holds the pencil, book marks, extractable note paper, and unique Learning Assist Note Taking Guidelines (short form card) to be attached within a book; in a compact semi-concealed way such that all these tools are always handy to use while reading, yet contained out of the way such that the book can be handled, put in a book bag, or stored on a book shelf, as easily as the book alone. Though the holder with its contents can be moved from book to book, it is designed primarily to stay with the book; so the materials are always handy whenever the book is picked up.

The Learning Assist Note Taking Guidelines promote fast efficient note taking, by marking and writing directly in the book; which also makes the notes an integral, permanent part of the book. Only the pencil is used to write directly in the book. A pencil can be erased and corrected, and pencil marks maintain very well in long term storage. (A pen or color marker may potentially be used; but more extensive testing is required to avoid possible, long term, ink bleed, page-through visibility, or sticking pages, in the variety of papers used in the wide choices of unknown books.)

The Learning Assist Note Taking Guidelines accommodate classical, but improved, techniques for comments, cross referencing, brackets, and underlining; but especially adds the unique simple sketches that locate the text of importance, which simultaneously provide immediate visible hierarchy to that importance. This importance is incorporated into a very unique Note Lookup File that provides the reader fast access back to his/her text notes to refresh any specific knowledge, whenever wanted. This Note Lookup File, and all the text notes, are contained within the book itself, no pages are added, so the book becomes a single entity that serves as a valuable reference, and a long term resource for the reader.

Two features of this invention also apply to electronic medium reading. These two features are subsequently identified and described as Dependent Claims.

### (3) BRIEF DESCRIPTION OF THE DRAWING AND THE EXHIBIT

One Drawing and one Exhibit (accompanying) are provided with this invention:

FIG. 1: Book Learning Tool, HOLDER

Exhibit 1: Simulated Book Page

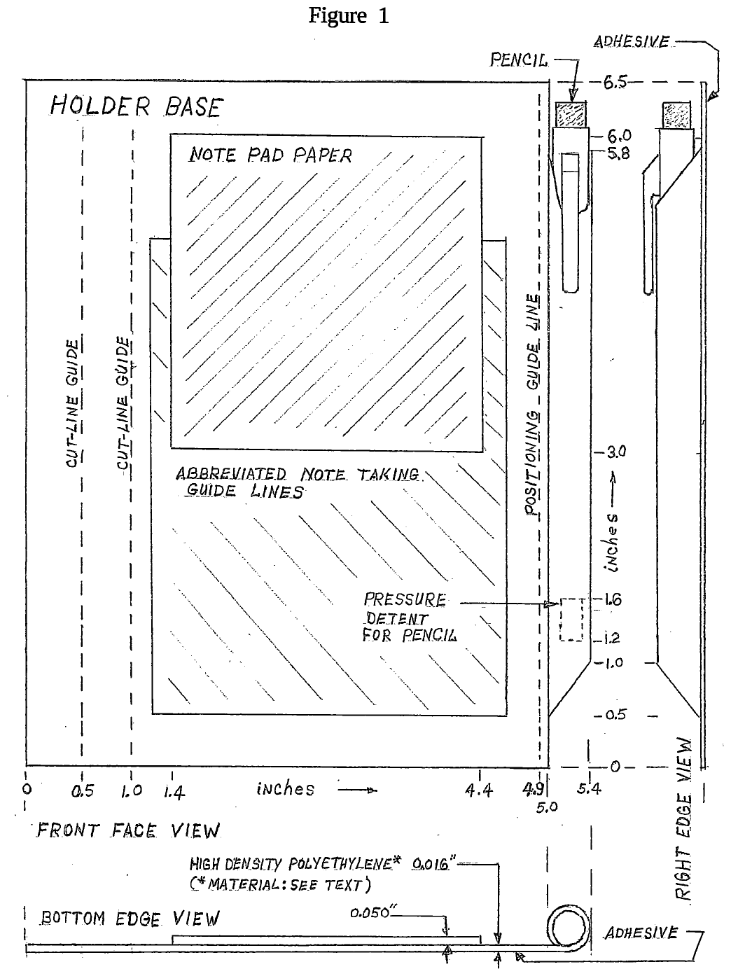

### BRIEF DESCRIPTION: FIG. 1: BOOK LEARNING TOOL

FIG. 1 shows the Book Learning Tool, HOLDER, with components; Holder Base, Pencil, Note Paper Pad, and Short Form Guide Card.

Three views are shown: Front Face View, Right Edge View, Bottom Edge View.

All dimensions for the Holder Base are shown on this drawing.

FIG. 1 is also referenced (2 places) under the Detailed Description Of The Invention: Physical;
prior to: The components list of the Book Learning Tool
and: The dimensions of the Holder Base

### BRIEF DESCRIPTION: EXHIBIT 1: SIMULATED BOOK PAGE

Exhibit 1 depicts a simulated right hand page of a reader's book. It is shown as an example of what a book page might look like after the reader has used a pencil to Underline, put in Brackets, and also Highlight Indicators.

Note: Exhibit 1: Simulated Book Page, is shown with a wider right margin than a normal book page, to allow adding brief notes in the margin, to help identify; the hand drawn Brackets, and the hand drawn Highlight Indicators (all three levels; single, double, and triple, are exhibited).

Exhibit 1 is also referenced (3 places) in the Detailed Description Of The Invention: Learning Assist Note Taking Guidelines;
under: item 2. Underlining
and: item 3. Brackets
and: item 6. Highlight Indicators.

### (4) DETAILED DESCRIPTION OF THE INVENTION

The Detailed Description Of The Invention: The description sequence is listed below:
first: Detailed Description Of The Invention: Physical
second: Detailed Description Of The Invention: Learning Assist Note Taking Guidelines

### Detailed Description of the Invention: Physical

The physical part of this invention is a Holder, that consists of a Holder Base that contains all the physical materials and a short form guide card of the Learning Assist Note Taking Guidelines. These components are listed below; and also shown in FIG. 1.
Holder Base
Pencil
Note Paper Pad, (book mark(s) and extractable note paper(s))
Short form guide card of the Learning Assist Note Taking Guide Lines

The Holder Base is made of a flexible durable material (preferably, but not limited to, high density polyethylene), that is coated with a sticky adhesive on the back (and covered with a protection paper until used) so the holder can be adhered to the inside of the back cover of a book. The adhesive is such that it will hold securely for all normal use, but allows the Holder to be removed if desired. It is intended and designed to normally stay with the book.

The dimensions of the Holder Base, see FIG. 1, accompanying, are chosen to fit a typical hard cover book. (These chosen design dimensions can be changed if desired.) The Holder is designed to be placed and adhered to the inside of the back cover of the book. It is designed so the right edge of the Holder is placed flush with the edge of the back cover of the hard cover book. There is a positioning guide line on the Holder near the right edge (approximately 0.1″ from the edge) that shows where the pages of the book will be when the book is closed. This allows room for the Pencil in the Holder to recede slightly inside the edge of the book's hard cover. This feature partially hides the Pencil between the book's front and back hard cover when the book is closed. This allows for easy handling and storage of the book with the Holder and all the materials in place. It also helps protect the Pencil when the book is handled roughly.

The Holder Base is designed so that it can also be used with a soft cover book. A soft cover book typically has the front and back covers that are flush with the pages, that is, the covers and the pages are the same dimension. When placing the Holder in a soft cover book, it is placed inside the back cover just as in a hard cover book, except the positioning guide line on the right side of the Holder is placed at the edge of the cover. This makes the right edge of the Holder protrude approximately 0.1″ beyond the cover (instead of flush as in a hard cover book). This allows the Pencil to leave room for the book to close nicely with the Pencil against the front edge of the pages. The Pencil against the pages and the slight protrusion of the right edge of the holder provides protection of the Pencil during rough handling. The flexibility of the soft cover book is somewhat reduced with the Holder in place, but the Holder Base material is flexible as well, so the two are still compatible.

Many soft cover books are smaller in height and width than the typical book. The Holder can easily be modified to fit the smaller book as well. Simply cutting off some of the left edge of the Holder Base, makes the Holder width to nicely fit the smaller book. The Holder Base material is such that it can easily be cut with normal office scissors. Two cut-line guides near the left side of the Holder are provided for this purpose. Rarely would there ever be a need to modify the vertical dimension.

The pad of Note Paper contained in the Holder serves multiple functions. The Note Paper sheets are used for the main Book Mark, for multiple place Book Marks when cross referencing, a Book Mark for the Note Lookup File, and as Note Paper that can be written on, extracted and carried apart from the book when it's desired to do so. The sticky adhesive on the back of each Note Paper sheet makes an excellent Book Mark because it will not fall out, it will stay in place when the book is handled.

A short form guide card of the Learning Assist Note Taking Guidelines is included on the Holder.

### Detailed Description of the Invention: Learning Assist Note Taking Guidelines

The Learning Assist Note Taking Guidelines consists of a written paper text that provides all of the information of this detailed description, plus a short form guide that is abbreviated and condensed to provide the reader with reminder information from the written paper text. This short form guide is a little card that is included on the Holder. It is listed on the component list above, under Detailed Description Of The Invention: Physical; and also referenced above, just preceding this paragraph.

The main objective of the Learning Assist Note Taking Guidelines is to enhance learning while reading a book; make all the desired notes while reading, and keep these notes within the book such that when the reading is done, the book is a single entity that provides the reader quick and easy access back to all the knowledge the reader has gained. A further objective is to keep the note taking fast and simple, so as to disrupt the reading a little as possible.

This is accomplished by the 7 techniques (items 1 through 7) described below:
1. Writing in the Book. All notes are written directly in the book. Most notes are notation sketches that locate where the important information of the text is. These notations are “sketched” into the book, and coupled with the identified text, are considered the actual notes taken; while reading (see item 6 below). This makes the note taking fast, and become a permanent, integral part of the book.
2. Underlining. Underlining in a limited fashion, that is, underline key words and phrases only; not complete sentences, nor paragraphs. This is faster and results in a quicker recognition of the desired specific information when re-reading because it reduces clutter. See also Exhibit 1.
3. Brackets. When a whole paragraph is deemed very important, the reader should still limit underlining to only key words and phrases, and simply add a “bracket” to identify the whole paragraph. A “bracket” is a single straight line down only the outside margin of the paragraph, with a small “boxed” corner at the top and bottom of the line to indicate the start and finish of the selected paragraph. This greatly reduces clutter. See also Exhibit 1.
Note: On a right hand page, the outside margin, is always on the right side of the text; conversely, on a left hand page, the outside margin is always on the left side of the text. This allows all margin notes to be quickly scanned by the reader, because they are always in the same place, namely, the book's outside margins. And, it reduces clutter.
4. Comments, Thoughts. The book's outside margins are used to write any short comments, notes, or thoughts the reader chooses to include; and also for the Highlight Indicators per item 6 below. If the comments or notes are longer (a sentence or more), it is suggested that the reader write them in the top, or bottom, margins of the text. A long note (paragraph) can be included by writing on a partially blank page of the Chapter end, and referenced by page number written into the top margin of the reading text.
Note: Writing and including these notes are encouraged because they renew the thoughts that can prove valuable to the reader upon review, and or, when used as a long term reference. Furthermore, writing thoughts while reading; enhances the reading, the memory, the comprehension, and the learning experience the reader gains during reading.
5. Cross Referencing. There are multiple uses for the Note Pad paper sheets as described above under the Detailed Description Of The Invention: Physical. Using the Note Pad sheets for Book Marks, when cross referencing, makes it convenient and saves time when the reader wants to go back and forth between information that is located in different parts of the book.
Note: It is intended that when the reader finishes reading the book, the reader takes the extra step of writing in the top margin, on the same page where each of the multiple cross referencing Book Marks is located, a quick note stating, “see also page xxx”, or “see also pages xxx, yyy, and zzz”. These are the page numbers where the other cross reference Book Marks of related information are located. The cross reference Book Mark paper sheets can then be discarded, because the cross referencing is preserved in these “page xxx” top margin notes.
6. Highlight Indicators. These are unique little sketches; sketched in the outside margins to locate and identify the sentence(s) of interest. These sketches are simple and quick; and are herein named “Highlight Indicators”. They are a notation indicator (a sketch); and along with the identified text, are considered the actual reading note, that has been taken while reading (see item 1 above). They can be used alone and independent of, or in conjunction with, underlining and brackets.

These sketches have a very useful function. The sketches are described below; their important function is explained subsequent to these descriptions. Actual sketches are shown in Exhibit 1.

“Highlight Indicator” sketches; described: There are three types, or levels, of Highlight Indicator sketches. These are single, double, and triple.

Single: (Right hand page) A single short line sketched from the right edge of the text's sentence of interest, into the right outside margin, and terminated by a star, an asterisk, small circle, or similar. (Left hand page) A single short line sketched from the left edge of the text's sentence of interest, into the left outside margin, and terminated by a star, an asterisk, small circle, or similar.

Double: Sketched just as though two adjacent single sketches were used, one below the other; except the short lines of each, are joined to form an apex near the sentence of interest. Thus, there is one apex with two short lines, each with a star, or similar. They are located in the outside margin of a page just as a single sketch is used.

Triple: Sketched just as though three adjacent single sketches were used, one below the other; except the short lines of each, are joined to form an apex near the sentence of interest. Thus, there is one apex with three short lines, each with a star, or similar. They are located in the outside margin of a page just as a single sketch is used.

“Highlight Indicator” functions; described: (there are three functions):

First, they are an obvious physical sketch that quickly draws the reader's eye to the important sentence of interest. In this, they provide an additional location function to an underline.

Second, they contain an immediate indication of the importance the reader chooses to assign to the sentence. Thus, they provide levels of hierarchy. (Underlining does not provide this.)
single sketch indicates: Important.
double sketch indicates: More Important.
triple sketch indicates: Very Important.

Third, all sketches are located only in the outside margins of the pages. This makes it easy for the reader to scan and find what they have read, while accounting for the importance of the information. This is valuable to the reader during the reading process, as well as a means to quickly find their way back to the information at a later time. Thus, the “Highlight Indicator” sketches of this item 6, provide a perfect setup, to work in conjunction with the final component of the Learning Assist Note Taking Guidelines, namely; the Note Lookup File, item 7 listed below.
7. Note Lookup File. The Note Lookup File is a structured list of the reading notes, that the reader has selected to be of sufficient importance, that they will most likely want to return to; to support memory, comprehension, clarification, learning, review, details, quotation accuracy, verification, and on and on. These various needs exist throughout the reading process; during the reading, for review after reading, a near future reference, and when used as a long term resource. This File is of utmost importance because it is the “fast return path” for the reader back to this wanted information.

The Note Lookup File functional structure described: The Note Lookup File is structured to search for the selected notes via their information content. This is vital, because these are the notes the reader selected while reading, to be of sufficient importance, that he/she would most likely want to return to. Thus, it is natural that the reader's own thoughts and memories are what the reader uses to search for the information he/she wants to recall, to refresh and review. It is specific to the “topic/subject/content” information, that the reader is looking for. It is from the reader's own mind, and thus bypasses the book's organization and table of contents. The reader does not have to try and remember where, in the book he/she read what, and spend time trying to find it.

The Note Lookup File said “topic/subject/content” information (from above) described: The information to identify any noted text is described by its topic, subject, and content. When entered into the Note Lookup File, this “topic/subject/content” information is abbreviated. Identifying the note by abbreviating the description, optimizes the search; by keeping the identification simple, and easy to recognize. This also minimizes writing and keeps the Note Lookup File as small as possible.

This Lookup File is created using the following format: (page #, abbreviated topic/subject/content). The first part; (page #): This is book's page number where the text of the selected note is located. The second part; (abbreviated topic/subject/content): The information content of the selected note. The topic, subject, and content of the note is described (abbreviated) in as few words as prudent to identify it. This format is used for each selected note, and the abbreviation of the note is written only once, as it is entered in the Note Lookup File. This makes writing it simple and quick.

The abbreviation is accomplished as follows: The reader chooses about “three to eight” words to describe the (abbreviated topic/subject/content) to identify it. These words are the reader's own choices, thus making these words more recognizable when returning to find the information the reader wants. The words chosen should capture any unique information content of the note.

Note: This abbreviation word choice is the most time consuming part of the whole Learning Assist Note Taking Guidelines. It stands apart from all the other quick and easy steps. But it should not be dismissed. The mental exercise required to choose the right “three to eight” words, to describe and “abbreviate” the information content to identify the selected “very important” notes of the book; is a valuable summarizing, and a surprisingly valuable learning assist, to the reader. This feature adds significant learning value to the Note Lookup File; in addition to the original objective of just providing the desired fast return path to information. It is thus, a significant boost to the learning objective of the whole “Book Learning Tool”.

The selection of the sufficiently important notes to become part of the Note Lookup File, is done by the reader during reading. In selecting this important note, the reader simply identifies it with the triple sketch “Highlight Indicator”. Per item 6 above, this triple sketch is deemed “very important”. If the reader notices a note that he/she has identified with only a double sketch, and wishes to add it to the Note Lookup File, he/she has only to add a line to the sketch to make it a triple. These triple sketches are obvious in the book's margins. These are the notes that are to be entered into the Note Lookup File. The selected notes are thus identified prior to the construction of the Lookup File.

It is strongly recommended that the “very important” notes selected by the reader to become part of the Note Lookup File, be moved to that File on a periodic basis. Ideally, this should be done immediately after reading a Chapter. This summarizes the Chapter, the notes are still fresh in the reader's mind, and the abbreviation process is easier. This also insures that the creation of the Note Lookup File stays synchronized with the reading process; namely, when book is done reading, so is the Note Lookup File. If this is not done, this File may be left undone, and this benefit is not gained.

The Note Lookup File physical structure described: This File is created on a blank page that is available in essentially every book. A single blank page, perhaps two, is normally all that is needed. This blank page, or two, will become the Note Lookup File. This also makes this File the desired integral, and permanent, part of the book. No auxiliary pages are ever added to the book.

The first step is to select the blank page (or two), preferably near the front of the book. A Publisher typically leaves a blank page or two, before or after the Forward, the Introduction, the Contents, etc. If none are available, there are typically blank pages in the back of the book near the Index.

Note: If the blank pages selected to become the Note Lookup File (page x, and/or second page y), do not display page numbers, the reader should write them in, using the book's paging sequence. The book's page sequence number, page x, is needed to identify the primary (first) page of this File.

When the Note Lookup File primary page x is identified, that page number, should be written on the very first page of the book, just inside the book's front cover. “Note Lookup File: page x”; is written on this very first page. A Book Mark from the Note Paper Pad is initially put on page x, to make access to this File more convenient during the reading process. This Book Mark can later be discarded, because “Note Lookup File: page x”, is still written on the front page. (This allows the reader, at a later time, to just open the front cover, page x is immediately known, and the reader has complete access to the Note Lookup File. This is used for the fast return path to the reader's notes.)

The next step is to prepare the Note Lookup File on the blank page x. The reader should write “Note Lookup File” at the top of this page x. As stated above, all the subsequent Note Lookup File entries are in the format: (page #, abbreviated topic/subject/content). This format is a short phrase, and as each new entry is written below the previous entry; the series of entries forms a column.

The structure of this column of entries is maintained by following the page sequence of the book. The page #, is the book's page number that the selected note is on. This defines the location of the selected note. As these selected notes are entered sequentially, the page sequence of the book is automatically followed. There will be page number gaps because many pages will not contain notes selected. Likewise, a page number may be listed twice because the reader may select two notes on the same page. But, the overall page structure of this File, thus follows the book's page sequence throughout the whole book. The sequence order of the selected notes is maintained as well.

Note: Because the entry format is a short phrase, it is often desirable to put two columns of entries on a single Note Lookup File page. This may eliminate the need of using two pages.

A small line sketched in the column can be entered to indicate the book's chapter number, if desired.

1. I claim a method of helping a book reader to enhance learning by quickly marking directly in the book, the location of the reader's selected sentence(s) of interest, such that both the location and the reader's judgment of importance, of the said selected sentence(s) is simultaneously visible and obvious, that in turn obtains the subsequent below listed desired results; this is accomplished in the following manner: using a pencil to sketch one of three levels of importance (hierarchy), in the outside margin of the text (the right margin of a right hand page, the left margin of a left hand page); starting at the outside margin edge of the text's said selected sentence of interest;
a) a single short line, sketched into the outside margin and terminated by a star, asterisk, small circle, or similar, is considered the first level of importance of the said hierarchy; (important); or,
b) two short lines (adjoined to form one apex at the edge of the text, one line above, one below the other, separating at a small angle), each line sketched into the outside margin and terminated with its own star, asterisk, or similar, is considered the second level of the said hierarchy; (more important); or
c) three short lines (adjoined to form one apex at the edge of the text, one line above, one below, the middle line, separating at a small angle), each line sketched into the outside margin and terminated with its own star, circle, or similar, is considered the third level of the said hierarchy (very important);
d) (it is noted that these said sketches, a), b), c), are referred to and named “Highlight Indicators”, in item 6, in the (4) Detailed Description Of The Invention, portion of this patent application);
the resulting effect of these sketches, obtains the said subsequent below listed desired results:
1) quickly draws attention to the location of the said selected sentence(s) of interest; and,
2) simultaneously visually identifies the importance the reader chooses to assign to the said selected sentence(s) of interest; and,
3) all the sketches located in the outside margins of the text, allows the reader to quickly scan to find and review what the reader wants to refresh, and it eliminates text clutter; however, key word and short phrase underlining added in the text, is helpful to quickly identify the subject of interest; and,
4) the level of importance the reader chooses to assign to the said selected sentence(s), is a product of the author's viewpoint, as well as the reader's own choices of interest, and desires of further understanding; all three require greater attention, and thus, obtains greater learning; and,
5) a single entity and permanent resource (the book with all sketch marks included) for a later date return to support memory, comprehension, learning, details, verification, quotation accuracy, and the many other reasons the reader may want.

2. I claim a method of helping a book reader, enhance learning and expand the value of the reading experience, by adding a “fast return path”, created by the reader, back to the text where the reader has already identified and selected the “very important” information(s), that the reader will most likely want to return to: the reader can accomplish this by these following steps:
a) the reader chooses a blank page, or two, typically available between the book's front cover, title page, and chapter listing, then identifies that blank page, page x, to become the “Note Lookup File”;
b) the reader writes, “Note Lookup File: page x”, on the book's first page, just inside the front cover;
c) this said “Note Lookup File”, to be created on page x, provides the said “fast return path”; entries to this said File list only the said “very important” information(s) selected while reading; and,
d) as each of the selected said “very important” information(s) is entered into this said File, the page number of its location in the book is listed first, followed and identified by describing the topic, subject, and content with as few words as prudent (about 3 to 8), to keep the description brief and easy to quickly recognize, because this “brief description” will be used to search for the wanted information, when later using the said “fast return path”; also,
e) entries to this said File are listed in the same order as they occur in the text, and should be done periodically (preferably after reading each chapter), this makes the said File easy to create; thus,
f) following the above said steps, completes the said Note Lookup File (the said “fast return path”) and provides the following desired results, listed below:
1) to use the said Note Lookup File, the reader opens the book's front cover, the first page shows the said File's location on page x, the said File's topic/subject/content said “brief descriptions” are scanned to identify the wanted information, the associated page number gives the location in the text, and the reader is returned to the said “wanted information” in the text reading environment; (this is the desired said “fast return path” in action; no need to try and remember where, in the book the reader read what and spend time trying to find it); and,
2) in creating the Note Lookup File, the needed summarizing activity strongly carries out the said “enhanced learning” objective, and the deep attention required to describe the said topic/subject/content greatly supports the said “expands the value of the reading experience” objective; and,
3) using the blank page x to contain the said Note Lookup File within the book, no pages are added, creates a single entity and valuable permanent resource (the book with all reader notes included; another Book Learning Tool objective) for a later date return to support memory, comprehension, learning, details, verification, quotation accuracy, and the many other reasons the reader may want.

3. I claim a utility device, that is a physical “Holder”, that eases and supports book reading, by keeping all the tools and materials necessary for efficient note taking contained in the said “Holder”, the said “Holder” is designed to be attached within and stay with the book, in a compact semi-concealed way such that all these said tools and materials are always available and handy to use while reading and whenever the book is picked up for reading, yet contained out of the way such that the book can be handled, transported, put in a book bag, or stored on a book shelf, as easily as the book alone;
the said “Holder” consists of a Holder Base that holds all the necessary said tools and materials which are the pencil, book marks, extractable note paper, and a short form guide card of the unique Learning Assist Note Taking Guidelines (or similar equivalent);
the said Holder Base is made of a flexible durable material (preferably, but not limited to, high density polyethylene), that is coated with a sticky adhesive on the back (and covered with a protection paper until used) so the said “Holder” can be adhered to the inside of the back cover of a book, the adhesive is such that it will hold securely for all normal use, but allows the said “Holder” to be removed if desired;
when the said “Holder” is attached within the book, the said Holder Base with all its components is contained within the book, except the said Holder Base is extended to hold the pencil just outside the book and against the front edge of the book pages;
the dimensions of the said Holder Base that is contained within the book (5.0×6.5×0.05 inches) are chosen to fit a typical hard cover book or similar sized soft cover book, though these chosen design dimensions can be changed if more convenient dimensions are found to be desired;
for hard cover, or soft cover, books that are smaller in height and width than the said typical size book, the said Holder Base can easily be modified to nicely fit the smaller book by simply cutting off some of the left edge of the said Holder Base, (two cut-line guides near the left side of the said Holder Base are provided for this purpose, the said Holder Base can easily be cut with normal office scissors); rarely would there be a need to modify the vertical dimension;
this said utility device, the said “Holder”, thus, provides a compact semi-concealed device to ease and support note taking while reading by always being available when needed; and it can be removed from the book, or remain in the book and stored in the same space required for the book itself.
